(19) United States
(12) Patent Application Publication
(10) Pub. No.: US 2010/0176712 A1
(43) Pub. Date: Jul. 15, 2010

(54) LIGHT EMISSION DEVICE AND DISPLAY DEVICE HAVING THE SAME

(76) Inventors: Hyeong-Rae Seon, Suwon-si (KR); Hyun-Wook Kim, Suwon-si (KR)

Correspondence Address: CHRISTIE, PARKER & HALE, LLP, PO BOX 7068, PASADENA, CA, 91109-7068, US

(21) Appl. No.: 12/650,353

(22) Filed: Dec. 30, 2009

(30) Foreign Application Priority Data
Jan. 15, 2009 (KR) 10-2009-0003506

(51) Int. Cl. H01J 1/62

(52) U.S. Cl. 313/496

(57) ABSTRACT

A light emitting device and a display device having the same that are capable of being manufactured by a simplified manufacturing method and having an improved alignment characteristic of members constituting an electron emission unit of the light emitting device. In one embodiment, the light emitting device includes a first substrate assembly including a first substrate having first recess portions and second recess portions, electron emission regions, first electrodes coupled to the electron emission regions, and second electrodes; and a second substrate assembly facing an inner surface of the first substrate. Here, each of the first recess portions has a first depth, each of the second recess portions has a second depth smaller than the first depth, the first electrodes are positioned within the first recess portions, and the second electrodes are positioned within the second recess portions.

### CROSS-REFERENCE TO RELATED APPLICATION

This application claims priority to and the benefit of Korean Patent Application No. 10-2009-0003506, filed in the Korean Intellectual Property Office on Jan. 15, 2009, the entire content of which is incorporated herein by reference.

### BACKGROUND

1. Field

Embodiments of the present invention relate to a light emitting device and a display device having the same.

2. Description of the Related Art

A light emitting (emission) device can refer to a device that emits light and includes a front substrate with a phosphor layer and an anode electrode, and a rear substrate with an electron emission region and a driving electrode. The front substrate and the rear substrate form a vacuum chamber together with a sealing member by integrally bonding edges (or edge portions) thereof by utilizing the sealing member and exhausting the internal space.

The driving electrode includes a cathode electrode, and a gate electrode that is positioned at an upper part of the cathode electrode with an insulation layer disposed therebetween and that is formed in a direction crossing the cathode electrode. In each of crossing areas of the cathode electrode and the gate electrode, an opening is formed in the gate electrode and the insulation layer, and the electron emission region is disposed on the cathode electrode at the inside of the opening of the insulation layer. The driving electrode and the electron emission region constitute an electron emission unit.

When a certain or predetermined driving voltage is applied to the cathode electrode and the gate electrode, an electric field is formed around the electron emission region by a voltage difference between the two electrodes and thus electrons are emitted from the electron emission region. The emitted electrons are guided by a high voltage that is applied to the anode electrode to collide with the phosphor layer and allows light to be emitted from the phosphor layer by exciting the phosphor layer.

Because the electron emission unit of the above-described structure should be manufactured by repeating a thin film process and a thick film process several times, the manufacturing method thereof is complicated, and it is very important to align members constituting an electron emission unit at each manufacturing step and an additional effort for checking alignment is needed, such that a great deal of time and cost are required in manufacturing the electron emission unit.

The above information disclosed in this Background section is only for enhancement of understanding of the background of the invention and therefore it may contain information that does not form the prior art that is already known in this country to a person of ordinary skill in the art.

### SUMMARY OF THE INVENTION

Aspects of embodiments of the present invention are directed toward a light emitting (emission) device including an electron emission unit and a display device having the same that can improve a structure of a substrate with the electron emission unit that emits electrons.

Aspects of embodiments of the present invention are directed toward a light emitting device and a display device having the same that are capable of being manufactured by a simplified manufacturing method and having an improved alignment characteristic of members constituting an electron emission unit of the light emitting device.

An exemplary embodiment of the present invention provides a light emitting device including: a first substrate assembly including: a first substrate having first recess portions and second recess portions, electron emission regions, first electrodes electrically coupled to the electron emission regions, and second electrodes; and a second substrate assembly including: a second substrate facing the first substrate, and a light emitting unit including a phosphor layer on the second substrate. Here, each of the first recess portions has a first depth, each of the second recess portions has a second depth smaller than the first depth, the first electrodes are positioned within the first recess portions, and the second electrodes are positioned within the second recess portions.

In one embodiment, the first recess portions extend along a first direction, and the second recess portions connect neighboring ones of the first recess portions in a second direction crossing the first direction.

In one embodiment, the first electrodes are positioned one by one at each of the first recess portions, and the second electrodes are each positioned over multiple ones of the second recess portions. The multiple ones of the second recess portions corresponding to each of the second electrodes may be separated from each other in the second direction.

In one embodiment, the electron emission regions are on the first electrodes, and portions of the second electrodes that do not overlap with the first electrodes are positioned within the second recess portions, and portions of the second electrodes that overlap with the first electrodes are separated from the first electrodes and the electron emission regions in at least two spatial dimensions.

In one embodiment, the electron emission regions are on the first electrodes, and the first depth is larger than the sum of the second depth, a thickness of a corresponding one of the first electrodes, and a thickness of a corresponding one of the electron emission regions.

In one embodiment, the second recess portion is formed by removing a part of the first substrate.

In one embodiment, the second recess portion is formed by barrier ribs that are mounted on the first substrate.

In one embodiment, a bottom surface of each of the second recess portions is formed flat, and each of the second electrodes contacts the bottom surface of a corresponding one of the second recess portions.

In one embodiment, each of the second recess portions has a width larger than that of a corresponding one of the second electrodes.

In one embodiment, the light emitting device further includes a sealing member between the first substrate assembly and the second substrate assembly and for bonding the first substrate assembly to the second substrate assembly; and parts of the second electrodes are fixed to the first substrate assembly by the sealing member.

In one embodiment, each of the second electrodes is formed with a metal plate.

In one embodiment, the second electrodes have mesh portions in which openings for passing through electrons are formed, and support portions each enclosing a corresponding one of the mesh portions. The mesh portions may be provided one by one in each of the second electrodes. Alternatively, the mesh portion may correspond to a crossing region of a corresponding one of the first electrodes and a corresponding one of the second electrodes, and multiple ones of the mesh portions may be provided in each of the second electrodes.

Another embodiment of the present invention provides a display device including the above described light emitting device according to embodiments of the present invention, and a display panel that is positioned at the front of the light emitting device and that receives light from the light emitting device to display an image.

A light emitting device according to an embodiment of the present invention has a first recess portion at which the first electrode is positioned and a second recess portion at which the second electrode is positioned, and the first and second electrodes are positioned within the first and second recess portions, respectively, thereby easily aligning the first and second electrodes. Accordingly, an alignment process can be simplified and time and cost for alignment can be reduced, and thus a manufacturing process can be simplified.

Further, because the second electrode is fixed within the second recess portion, the second electrode can be firmly fixed at a certain or predetermined gap from the electron emission region without a separate fixing mechanism.

In this case, the first recess portion is formed to extend along a first direction while having a first depth, the second recess portion is formed by connecting the first recess portions in a second direction while having a second depth that is smaller than a first depth, and the crossing region of the first electrode and the second electrode can be fixed while sustaining an insulation state.

Further, by adjusting the first depth and the second depth, the mesh portion of the second electrode can be closely positioned at the electron emission region, and by reducing the initial spreading angle of electrons, charging of a side wall of the first recess portion can be suppressed. Therefore, driving can be stabilized by increasing withstand voltage characteristics of the first electrode and the second electrode, and high luminance can be embodied by increasing an anode voltage. Further, because a thick film process for forming an insulation layer and a thin film process for forming a gate electrode can be omitted, the manufacturing process of the light emitting device can be simplified and the manufacturing cost can be reduced.

An display device according an embodiment of the present invention can include the above described light emitting device.

### BRIEF DESCRIPTION OF THE DRAWINGS

FIG. 1 is a partial perspective view of a light emitting (emission) device according to an exemplary embodiment of the present invention.

FIG. 2 is a partial cross-sectional view of the light emitting device taken along a length direction of a second electrode of FIG. 1.

FIG. 3 is a partial cross-sectional view of the light emitting device taken along a width direction of a second electrode of FIG. 1.

FIG. 4 is a partial cross-sectional view of a light emitting device taken along a width direction of a second electrode according to another exemplary embodiment of the present invention.

FIG. 5 is a partial perspective view of a light emitting device according to another exemplary embodiment of the present invention.

FIG. 6 is an exploded perspective view of a display device according to an exemplary embodiment of the present invention.

FIG. 7 is a partial cross-sectional view of a display panel that is shown in FIG. 6.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

When it is said that a first part, such as a layer, film, region, or plate, is positioned on a second part, the first part can be directly on the second part or above the second part with at least one intermediate part therebetween. If a first part is said to be positioned directly on a second part, it refers to a situation where there is no intermediate part between the first and second parts.

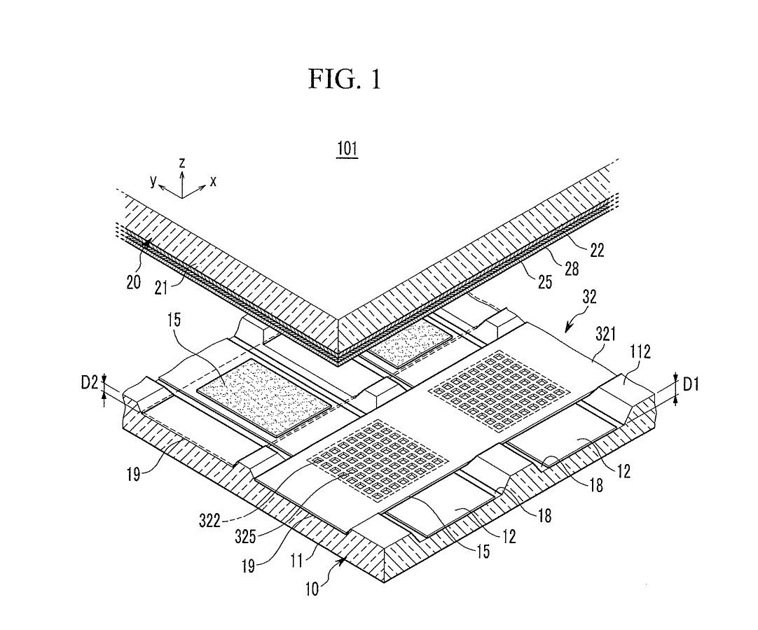

Hereinafter, a light emitting (emission) device 101 according to exemplary embodiment of the present invention will be described with reference to FIGS. 1 to 3.

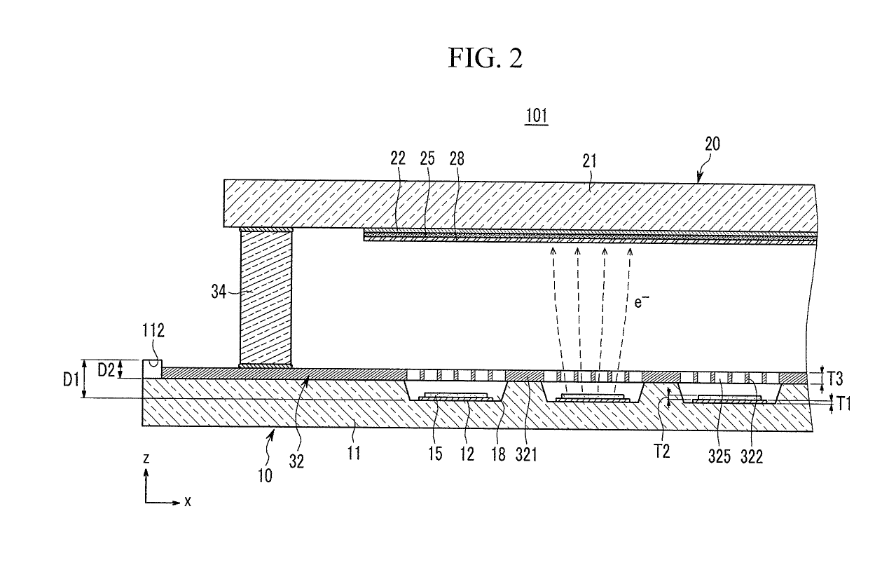

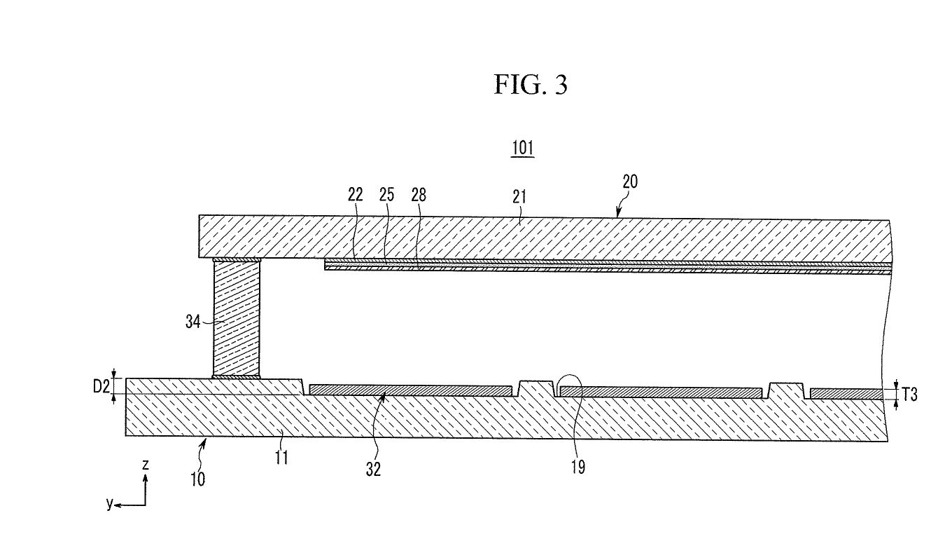

FIG. 1 is a partial perspective view of the light emitting device 101 according to an exemplary embodiment of the present invention. FIG. 2 is a partial cross-sectional view of the light emitting device 101 taken along a length direction (x-axis direction in the drawing) of a second electrode of FIG. 1, and FIG. 3 is a partial cross-sectional view of the light emitting device 101 taken along a width direction (x-axis direction in the drawing) of a second electrode of FIG. 1.

Referring to FIGS. 1 to 3, the light emitting device 101 includes a vacuum chamber that is formed with a first substrate assembly 10 and a second substrate assembly 20 that are arranged to face each other (with a gap therebetween), and a sealing member 34 that is disposed between the first substrate assembly 10 and the second substrate assembly 20 to bond the substrate assemblies 10 and 20 together. The inside of the first substrate assembly 10, the second substrate assembly 20, and the sealing member 34 is in a vacuum state that sustains a vacuum degree of about 10⁻⁶ Torr.

The first substrate assembly 10 includes a substrate main body (hereinafter, a “first substrate”) 11, a first electrode (hereinafter, a “cathode electrode”) 12 that is formed in the first substrate 11, an electron emission region 15, and a second electrode (hereinafter, a “gate electrode”) 32. Here, the cathode electrodes 12 are formed to extend along a first direction (y-axis direction in the drawing) of the first substrate 11, and the gate electrodes 32 are formed to extend along a second direction (x-axis direction in the drawing) crossing the first direction of the cathode electrodes 12 at an upper part of the cathode electrodes 12. In the drawings, the cathode electrodes 12 and the gate electrodes 32 have a stripe shape, but the shape of the cathode electrodes 12 and the gate electrodes 32 is not limited thereto and the cathode electrodes 12 and the gate electrodes 32 can have any suitable electrode shape that can control electron emission.

In the present exemplary embodiment, first recess portions 18 and second recess portions 19 to which the cathode electrodes 12 and the gate electrodes 32, respectively, are to be fixed are formed in an inner surface (surface opposite to the second substrate assembly 20) of the first substrate 11. The first recess portions 18 and the second recess portions 19 have a flat bottom surface to allow the cathode electrodes 12 and the gate electrodes 32, respectively, to stably closely contact thereto.

In more detail, in an inside surface of the first substrate 11, the first recess portions 18 having a first depth D1 are formed in a stripe shape to extend along a length direction of the cathode electrode 12, and the cathode electrode 12 is positioned at a bottom surface of the first recess portion 18. The first recess portion 18 has a larger width than that of the cathode electrode 12 to allow the cathode electrode 12 to be stably formed in the first recess portion 18. However, the present invention is not limited thereto, and the first recess portion 18 may be formed with the same width as that of the cathode electrode 12.

The first recess portions 19 may be formed by removing a part of the first substrate 11 using a method such as etching and/or sandblasting. The first recess portion 19 may have a vertical side wall or an inclined side wall. In the drawings, the first recess portion 19 having an inclined side wall is exemplified.

As an example, the first substrate 11 may have a thickness of about 1.8 mm, and the first recess portion 18 may have a depth of about 40 μm and a width of 300 μm to 600 μm.

Because the cathode electrode 12 is positioned at the bottom surface of the first recess portion 18, the cathode electrode 12 is positioned lower by a certain or predetermined height difference to an upper surface 112 of the first substrate 11, i.e., at an inner surface of the first substrate 11 in which the first recess portion 18 and the second recess portion 19 are not formed. Therefore, a portion of the first substrate 11 that is positioned between the first recess portions 18 functions as a wall for separating the neighboring cathode electrodes 12.

The electron emission region 15 is formed on the cathode electrode 12. FIG. 1 illustrates a case where the electron emission region 15 is formed only in a crossing region of the cathode electrode 12 and the gate electrode 32, but the present invention is not limited thereto. Therefore, the electron emission region 15 may be formed to have a stripe shape extending in parallel with the cathode electrode 12 on the cathode electrode 12.

The electron emission region 15 may include materials such as a carbon-based material and/or a nanometer size material that can emit electrons when an electric field is applied in a vacuum atmosphere. For example, the electron emission region 15 may include a material that is selected from a group consisting of carbon nanotubes, black lead, black lead nanofibers, diamond, diamond-like carbon, fullerene C₆₀, silicone nanowire, and combinations thereof.

The electron emission region 15 is formed by a thick film process such as screen printing. That is, the electron emission region 15 is formed by sequentially performing a printing process of screen-printing a paste mixture including an electron emission material on the cathode electrode 12, a drying and baking process of drying and baking the printed mixture, and a surface activation process of exposing electron emission materials on a surface of the electron emission region 15.

The surface activation process is formed with an operation of attaching and removing an adhesive tape on the electron emission region 15, and is performed before fixing the gate electrodes 32 on the first substrate 11. The electron emission materials such as carbon nanotubes can be formed substantially vertically on a surface of the electron emission region 15, while removing a part of a surface of the electron emission region 15 through the surface activation process.

In the present exemplary embodiment, by forming a first depth D1 of the first recess portion 18 to be greater than the sum of thicknesses of the cathode electrode 12 and the electron emission region 15, the cathode electrode 12 and the electron emission region 15 are positioned at a certain or predetermined height from the upper surface 112 of the first substrate 11.

The second recess portions 19 having a second depth D2 that is smaller than the first depth D1 of the first recess portion 18 are formed in the first substrate 11, and the gate electrode 32 is positioned at the bottom surface of the second recess portions 19.

In more detail, the second recess portions 19 are formed by connecting the first recess portions 18 in a second direction (x-axis direction in the drawing) crossing the first recess portions 18 between the neighboring first recess portions 18. As seen two-dimensionally, in a portion other than a crossing region of the cathode electrode 12, each gate electrode 32 is fixed over a plurality of second recess portions 19 that are separated from each other in the second direction. The gate electrode 32 is positioned at an upper part of the cathode electrode 12 and the electron emission region 15 at a certain or predetermined distance from the electron emission region 15 in a crossing region of the gate electrode 32 and the cathode electrode 12.

In the present exemplary embodiment, because the width of the second recess portion 19 is formed to be greater than that of the gate electrode 32, the gate electrode 32 can be stably fixed. The first depth D1 of the first recess portion 18 is formed to be greater than the second depth D2 of the second recess portion 19, a thickness T1 of the cathode electrode 12, and a thickness T2 of the electron emission region 15. Accordingly, insulation of the gate electrode 32 and the electron emission region 15 can be automatically secured. That is, in the present exemplary embodiment, by adjusting the first depth D1 and the second depth D2, insulation of the gate electrode 32 and the electron emission region 15 can be automatically secured, and a distance between the gate electrode 32 and the electron emission region 15 can be easily adjusted.

In the present exemplary embodiment, the depth D2 of the second recess portion 19 is formed to be greater than a thickness T3 of the gate electrode 32, and thus the gate electrode 32 is positioned lower by a certain or predetermined height difference from the upper surface 112 of the first substrate 11. Therefore, a portion of the first substrate 11 that is positioned between the second recess portions 19 functions as a wall for separating the neighboring gate electrodes 32. However, the present invention is not limited thereto, and the depth D2 of the second recess portion 19 may be substantially equivalent to the thickness T3 of the gate electrode 32.

In the present exemplary embodiment, by fixing the gate electrode 32 that is separated from the cathode electrode 12 and the electron emission region 15 in an upper part thereof to the second recess portion 19, the gate electrode 32 can be firmly fixed at a certain or predetermined distance from the electron emission region 15. That is, because a separate structure for fixing the gate electrode 32 is not provided, the manufacturing process can be simplified and the manufacturing cost can be reduced.

Further, by positioning the gate electrode 32 within the second recess portion 19, an alignment process of the gate electrode 32 can be simplified and alignment accuracy thereof can be improved.

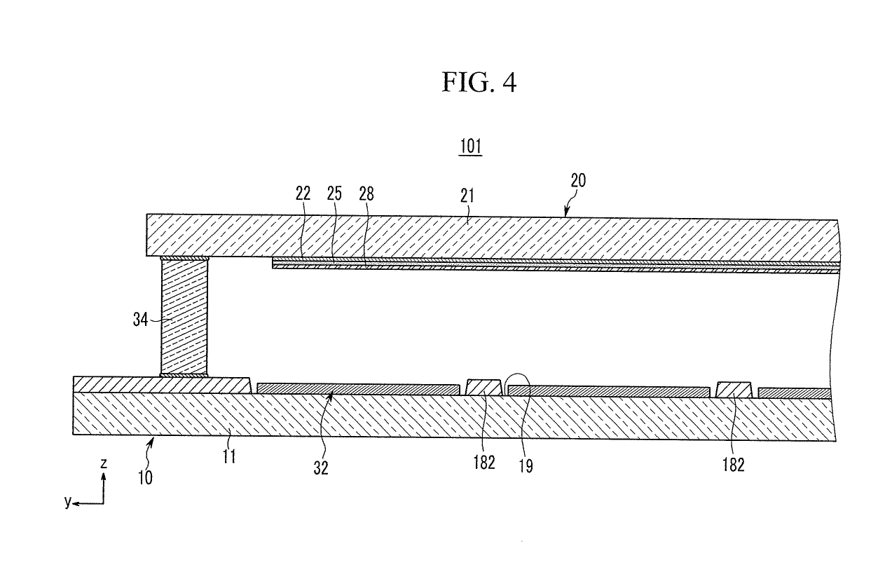

As shown in FIG. 3, the second recess portion 19 is formed by removing a part of the first substrate 11 using a method such as etching and/or sandblasting. Alternatively, in another exemplary embodiment of a light emitting device 101′ as shown in FIG. 4, by forming barrier ribs 182 in the second substrate 11 using a method such as thick film printing, the second recess portion 19 may be formed in space between a pair of neighboring barrier ribs 182.

The second recess portion 19 may have a vertical side wall or an inclined side wall. In the drawings, the second recess portion 19 having an inclined side wall is exemplified.

The gate electrode 32 can be manufactured with a metal plate having a certain or predetermined thickness, for example a thickness that is greater than that of the cathode electrode 12. Such a gate electrode 32 is fixed to the first substrate assembly 10 using the sealing member 34 without a separate fixing mechanism. That is, the entire gate electrode 32 is not fixed to the first substrate assembly 10, but the gate electrode 32 is fixed to the first substrate assembly 10 at only a portion of the gate electrode 32 at which the sealing member 34 is positioned by a bonding force and a compressive force of the sealing member 34, and the remaining portions are simply put in the first substrate assembly 10.

The gate electrode 32 is formed with a mesh portion 322 in which openings 325 for passing through electrons are formed, and a support portion 321 enclosing the mesh portion 322. For example, the gate electrode 32 can be manufactured through a step of forming the opening 325 by cutting a metal plate in a stripe shape and removing a part of the metal plate by a method such as etching.

In the embodiment, as shown in FIG. 1, the mesh portion 322 of the gate electrode 32 is formed only in a crossing region with the cathode electrode 12. Accordingly, by reducing line resistance of the gate electrode 32, a voltage drop can be minimized. However, the present invention is not limited thereto.

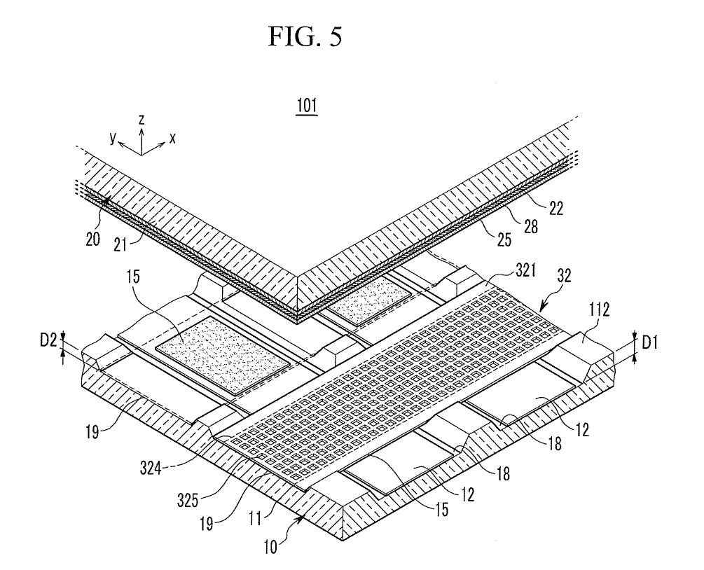

Therefore, in another exemplary embodiment of a light emitting device 101″, as shown in FIG. 5, a mesh portion 324 of the gate electrode 32 can be formed even in a portion that does not correspond to the cathode electrode 12 as well as a portion corresponding to the cathode electrode 12. That is, the openings 325 can be formed even in a portion that is fixed to the second recess portion 19, i.e., a portion closely contacting an upper surface of the first substrate 11. In this case, because a region of the gate electrode 32 other than both side end portions forms the mesh portion 324, when fixing the gate electrode 32 to the first substrate 11, it is unnecessary to consider alignment characteristics of the gate electrode 32 and the cathode electrode 12 in a length direction (x-axis direction in the drawing) of the gate electrode 32.

The gate electrode 32 may be made of a nickel-iron alloy and/or other suitable metal materials, and may be formed with a thickness of about 50 μm and a width of about 10 μm.

In one exemplary embodiment, one cathode electrode 12 is positioned at each first recess portion 18 by forming the first recess portion 18 having the first depth D1, and the gate electrode 32 is positioned at a plurality of second recess portions 19 (e.g., two second recess portions 19) having the second depth D2 that is smaller than the first depth D1. Thereby, the crossing cathode electrode 12 and gate electrode 32 are received within the first recess portion 18 and at the second recess portions 19 (e.g., the two second recess portions 19), respectively, while being insulated from each other.

In the light emitting device 101, 101′, 101″ of the above-described structures, one of crossing region of the cathode electrode 12 and the gate electrode 32 corresponds to one pixel area. Alternatively, two or more crossing regions may correspond to one pixel area, and in this case, the same driving voltage is applied to the cathode electrodes 12 that are positioned at the same pixel area, and the same driving voltage is applied to the gate electrodes 32 that are positioned at the same pixel area.

Next, the second substrate assembly 20 is formed by forming a light emitting unit with a substrate main body (hereinafter, a “second substrate”) 21. The light emitting unit includes an anode electrode 22 that is formed on an inner surface of the second substrate 21, a phosphor layer 25 that is positioned at one surface of the anode electrode 22, and a reflective layer 28 that covers the phosphor layer 25.

The anode electrode 22 is made of a transparent conducting material to transmit visible light that is emitted from the phosphor layer 25. For example, the anode electrode 22 may be made of a material such as indium tin oxide (ITO). The anode electrode 22 is an acceleration electrode that pulls electrons and sustains the phosphor layer 25 in a high potential state by receiving a positive DC voltage (anode voltage) of more than several thousand volts.

The phosphor layer 25 is formed with a mixed phosphor that emits white light by mixing red, green, and blue phosphors. The phosphor layer 25 is formed in an entire light emitting area of the second substrate 21, or is formed separately in each pixel area. FIGS. 1 and 2 illustrate a case where the phosphor layer 25 is formed in the entire light emitting area of the second substrate 21.

The reflective layer 28 that is formed on the phosphor layer 25 is formed with an aluminum thin film having a thickness of several thousand Å, and minute holes for passing through electrons are formed in the reflective layer 28. The reflective layer 28 performs a function of increasing luminance of the light emitting device 101 by reflecting visible light that is emitted toward the first substrate assembly 10 among visible light that is emitted from the phosphor layer 25.

Here, one of the anode electrode 22 and the reflective layer 28 may be omitted. When the anode electrode 22 is omitted, the reflective layer 28 receives an anode voltage to perform the same function as that of the anode electrode 22.

A spacer that uniformly sustains a gap between both substrates 10 and 20 while withstanding vacuum pressure is provided between the first substrate assembly 10 and the second substrate assembly 20. The spacers are positioned to correspond to the gate electrodes 32 therebetween.

In such a light emitting device 101, a scanning driving voltage is applied to one of the cathode electrode 12 or the gate electrode 32, a data driving voltage is applied to the other, and an anode voltage of more than several thousand volts is applied to the anode electrode 22.

Accordingly, in pixels in which a voltage difference between the cathode electrode 12 and the gate electrode 32 is a threshold value or more, an electric field is formed around the electron emission region 15 and thus electrons are emitted from the electron emission region 15. The emitted electrons are guided by an anode voltage that is applied to the anode electrode 22 to collide with a corresponding portion of the phosphor layer 25, thereby allowing the phosphor layer 25 to emit light. Luminance of the phosphor layer 25 on a pixel basis corresponds to an electron emission amount of the corresponding pixel.

In the present exemplary embodiments, by adjusting the first depth D1 and the second depth D2, the gate electrode 32 can be disposed directly on the electron emission region 15, and thus electrons that are emitted from the electron emission region 15 reach the phosphor layer 25 by passing through the opening 325 of the gate electrode 32 in a reduce or minimum beam spreading state. Therefore, in the light emitting device 101 according to the present exemplary embodiment, because an initial spreading angle of electrons is reduced, charging of a side wall of the recess portion 19 can be effectively suppressed.

As a result, by increasing withstand characteristics of the cathode electrode 12 and the gate electrode 32, driving is stabilized, and thus by applying a high voltage of 10 kV or more, in one embodiment, a high voltage of between 10 and 15 kV, to the anode electrode 22, high luminance can be embodied.

Further, in the present exemplary embodiment, because a thick film process of forming an insulation layer and a thin film process of forming a gate electrode may be omitted, the manufacturing process can be simplified. In a case of forming an entire gate electrode with a mesh portion, when disposing the gate electrode 32 at the first substrate 11, it is unnecessary to consider an alignment state of the cathode electrode 12, thereby obtaining an easier manufacturing process.

Moreover, because the gate electrode 32 is disposed after the electron emission region 15 is formed, a problem that the cathode electrode 12 and the gate electrode 32 are short-circuited by a conductive electron emission material can be reduced or prevented.

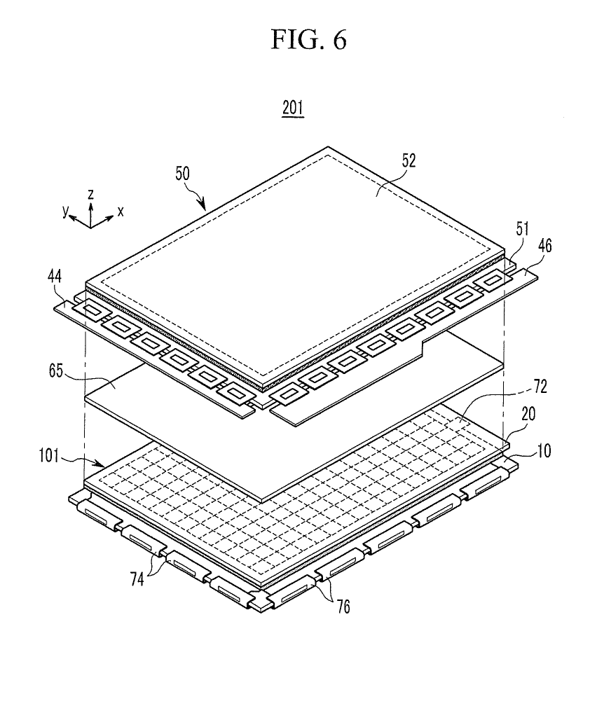

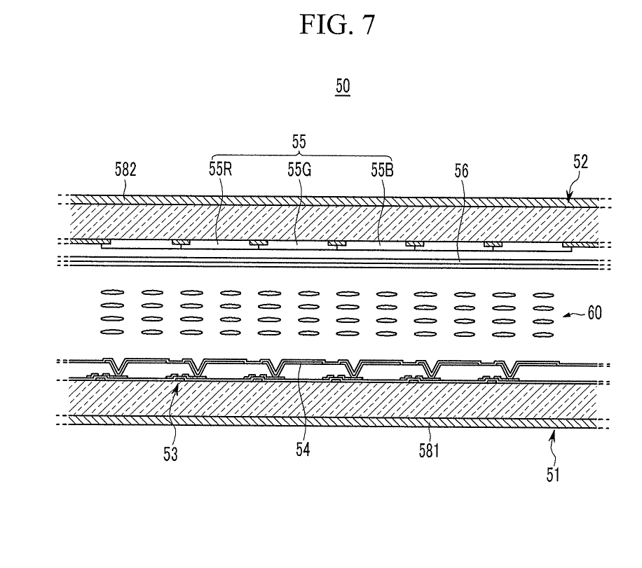

Hereinafter, a display device 201 according to an exemplary embodiment of the present invention will be described with reference to FIGS. 6 and 7.

FIG. 6 is an exploded perspective view of the display device 201.

The display device 201 includes the light emitting device 101 and a display panel 50 that is positioned at the front of the light emitting device 101. Here, although the light emitting device 101 is shown and described in the display device 210, the light emitting device in the display device 201 can be any one of the above-described exemplary light emitting devices 101, 101′ and 101″, and functions as a light source in the display device 201. The display panel 50 may be a transmissive or transflective liquid crystal display panel. A diffusion member 65 that evenly diffuses light that is emitted from the light emitting device 101 is positioned between the light emitting device 101 and the display panel 50.

FIG. 7 is a partial cross-sectional view of the display panel 50 that is shown in FIG. 6, and exemplifies a transmissive liquid crystal display panel. A case where the display panel 50 is a transmissive liquid crystal display panel is described with reference to FIG. 7.

Referring to FIG. 7, the display panel 50 includes a first display panel 51 in which a thin film transistor (TFT) 53 and a pixel electrode 54 are formed, a second display panel 52 in which a color filter layer 55 and a common electrode 56 are formed, and a liquid crystal layer 60 that is injected between the first display panel 51 and the second display panel 52. Polarizing plates 581 and 582 are attached to a front surface of the first display panel 51 and a rear surface of the second display panel 52 to polarize light that passes through the display panel 50.

The pixel electrodes 54 are positioned one by one at each subpixel, and driving thereof is controlled by the TFT 53. Here, a plurality of subpixels that embody different colors form a pixel, and the pixel becomes a minimum unit that displays an image. The pixel electrodes 54 and the common electrode 56 are made of a transparent conducting material. The color filter layer 55 includes a red filter layer 55R, a green filter layer 55G, and a blue filter layer 55B that are each positioned on a subpixel basis.

Particularly, when the TFT 53 of the subpixel is turned on, an electric field is formed between the pixel electrode 54 and the common electrode 56. An alignment angle of liquid crystal molecules of the liquid crystal layer 60 is changed by the electric field, and light transmittance changes according to the changed alignment angle of the liquid crystal molecules. The display panel 50 controls luminance on a pixel basis and a light emitting color through such a process to display an image.

The display panel 50 is not limited to the above-described structure, and can be formed to have various suitable structures.

Referring to FIGS. 6 and 7, the display device 201 includes a gate circuit board 44 that supplies a gate driving signal to the gate electrode of each TFT 53 of the display panel 50, and a data circuit board 46 that supplies a data driving signal to the source electrode of each TFT 53 of the display panel 50.

The light emitting device 101 allows a pixel of the light emitting device 101 to correspond to two or more pixels of the display panel 50 by forming pixels of a smaller number than that of the display panel 50. Each pixel of the light emitting device 101 emits light to correspond to a gray level of pixels of the display panel 50 corresponding thereto, and for example, emits light to correspond to a highest gray level of the gray levels of the pixels of the display panel 50. Each pixel of the light emitting device 101 can represent gray levels of a grayscale of 2 to 8 bits.

For convenience, a pixel of the display panel 50 is referred to as a “first pixel”, a pixel of the light emitting device 101 is referred to as a “second pixel”, and first pixels corresponding to a second pixel are referred to as a “first pixel group”.

A driving process of the light emitting device 101 includes allowing a signal controller that controls the display panel 50 to detect the highest gray level of first pixels of the first pixel groups, calculating a gray level necessary for emitting light of the second pixel according to the detected gray level and converting the calculated gray level to digital data, generating a driving signal of the light emitting device 101 using the digital data, and applying the generated driving signal to a driving electrode of the light emitting device 101.

The driving signal of the light emitting device 101 includes a scan signal and a data signal. One electrode of a cathode electrode (reference numeral 12 of FIG. 1, hereinafter the same) or a gate electrode (reference numeral 32 of FIG. 2, hereinafter the same)—for example the gate electrode 32—receives a scan signal, and the other electrode—for example the cathode electrode—receives a data signal.

Further, a data circuit board and a scanning circuit board for driving the light emitting device 101 are disposed at a rear surface of the light emitting device 101. The data circuit board and the scanning circuit board are connected to the cathode electrode 12 and the gate electrode 32 through a first connector 76 and a second connector 74, respectively. A third connector 72 applies an anode voltage to the anode electrode 22.

In this way, when an image is displayed in the corresponding first pixel group, the second pixel of the light emitting device 101 is synchronized with the first pixel group to emit light with a predetermined grayscale. That is, the light emitting device 101 provides light of high luminance to a bright region of a screen that is embodied by the display panel 50, and provides light of low luminance to a dark region thereof. Therefore, the display device 201 according to the present exemplary embodiment can increase the contrast ratio of a screen and embody a clearer image quality.

By such a configuration, the display device 201 includes the light emitting device 101 having improved alignment characteristics and electron emission characteristics.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A light emitting device comprising:
a first substrate assembly comprising:
a first substrate having first recess portions and second recess portions,
electron emission regions,
first electrodes electrically coupled to the electron emission regions, and
second electrodes; and
a second substrate assembly comprising:
a second substrate facing the first substrate, and
a light emitting unit comprising a phosphor layer on the second substrate,
wherein:
each of the first recess portions has a first depth,
each of the second recess portions has a second depth smaller than the first depth,
the first electrodes are positioned within the first recess portions, and
the second electrodes are positioned within the second recess portions.

2. The light emitting device of claim 1, wherein:
the first recess portions extend along a first direction, and
the second recess portions connect neighboring ones of the first recess portions in a second direction crossing the first direction.

3. The light emitting device of claim 1, wherein:
the first electrodes are positioned one by one at each of the first recess portions, and
the second electrodes are each positioned over multiple ones of the second recess portions.

4. The light emitting device of claim 3, wherein the multiple ones of the second recess portions corresponding to each of the second electrodes are separated from each other in the second direction.

5. The light emitting device of claim 1, wherein:
the electron emission regions are on the first electrodes, and
portions of the second electrodes that do not overlap with the first electrodes are positioned within the second recess portions, and portions of the second electrodes that overlap with the first electrodes are separated from the first electrodes and the electron emission regions in at least two spatial dimensions.

6. The light emitting device of claim 1, wherein:
the electron emission regions are on the first electrodes, and
the first depth is larger than the sum of the second depth, a thickness of a corresponding one of the first electrodes, and a thickness of a corresponding one of the electron emission regions.

7. The light emitting device of claim 1, wherein the second recess portion is formed by removing a part of the first substrate.

8. The light emitting device of claim 1, wherein the second recess portion is formed by barrier ribs that are mounted on the first substrate.

9. The light emitting device of claim 1, wherein a bottom surface of each of the second recess portions is formed flat, and each of the second electrodes contacts the bottom surface of a corresponding one of the second recess portions.

10. The light emitting device of claim 1, wherein each of the second recess portions has a width larger than that of a corresponding one of the second electrodes.

11. The light emitting device of claim 1, further comprising a sealing member between the first substrate assembly and the second substrate assembly and for bonding the first substrate assembly to the second substrate assembly,
wherein parts of the second electrodes are fixed to the first substrate assembly by the sealing member.

12. The light emitting device of claim 1, wherein each of the second electrodes is formed with a metal plate.

13. The light emitting device of claim 1, wherein the second electrodes have mesh portions in which openings for passing through electrons are formed, and support portions each enclosing a corresponding one of the mesh portions.

14. The light emitting device of claim 13, wherein the mesh portions are provided one by one in each of the second electrodes.

15. The light emitting device of claim 13, wherein the mesh portion corresponds to a crossing region of a corresponding one of the first electrodes and a corresponding one of the second electrodes, and multiple ones of the mesh portions are provided in each of the second electrodes.

16. A display device comprising:
a light emitting device comprising:
a first substrate assembly comprising:
a first substrate having first recess portions and second recess portions,
electron emission regions,
first electrodes electrically coupled to the electron emission regions, and
second electrodes; and
a second substrate assembly comprising:
a second substrate facing the first substrate, and
a light emitting unit comprising a phosphor layer on the second substrate,
wherein:
each of the first recess portions has a first depth,
each of the second recess portions has a second depth smaller than the first depth,
the first electrodes are positioned within the first recess portions, and
the second electrodes are positioned within the second recess portions; and
a display panel in front of the light emitting device and for receiving light from the light emitting device to display an image.

17. A light emitting device comprising:
a first substrate assembly comprising:
a first substrate having a first recess portion and at least two second recess portions, the first recess portion being between the at least two second recess portions,
an electron emission region,
a first electrode electrically coupled to the electron emission region, and
a second electrode; and
a second substrate assembly comprising:
a second substrate facing the first substrate, and
a light emitting unit comprising a phosphor layer on the second substrate,
wherein:
the first recess portion has a first depth,
each of the at least two second recess portions has a second depth smaller than the first depth,
the first electrode is positioned within the first recess portion, and
the second electrode is positioned within the at least two second recess portions.
